(19) United States
(12) Patent Application Publication
(10) Pub. No.: US 2015/0086053 A1
(43) Pub. Date: Mar. 26, 2015

(54) HEARING INSTRUMENT WITH BATTERY COMPARTMENT SWITCH

(71) Applicant: SIEMENS MEDICAL INSTRUMENTS PTE. LTD., SINGAPORE (SG)

(72) Inventors: UWE FLAIG, FEUCHT (DE); HOLGER KRAL, FUERTH (DE)

(21) Appl. No.: 14/494,776

(22) Filed: Sep. 24, 2014

(30) Foreign Application Priority Data
Sep. 24, 2013 (DE) 102013219135.9

(51) Int. Cl. H04R 25/00

(52) U.S. Cl. CPC H04R 25/602; H04R 25/65; H04R 2225/77
USPC 381/323

(57) ABSTRACT

A hearing instrument has a battery compartment switch which causes the hearing instrument to switch on/off. An electrical contact to the battery is established and interrupted by the battery compartment switch when the battery compartment is closed and opened. An on/off contour in the area of the battery compartment and a correspondingly shaped battery contact device are provided, the configurations are tailored, so that the lift-off area for lifting the battery contact device away from the battery and the contact area of the battery contact device are separated from one another. The battery contact device has a lift-off area and a contact area. Both areas are configured separately to reduce the wear on the on/off contour and to secure electrical contacting of the battery. This enables a lift-off area with a large surface, through which the mechanical pressure on the on/off contour is distributed and is thus reduced.

### CROSS-REFERENCE TO RELATED APPLICATION

This application claims the priority, under 35 U.S.C. §119, of German application DE 10 2013 219 135.9, filed Sep. 24, 2013; the prior application is herewith incorporated by reference in its entirety.

### BACKGROUND OF THE INVENTION

### Field of the Invention

The invention relates to a hearing instrument with a battery compartment switch which causes the hearing instrument to switch on/off when the battery compartment is closed and opened. For this purpose the electrical contact to the battery is established and interrupted by the battery compartment switch when the battery compartment is closed and opened.

Hearing instruments can be configured as hearing devices for example. A hearing device is used to supply a hearing-impaired person with acoustic ambient signals which are processed and amplified for compensation or therapy of the respective hearing damage. In principle the device contains one or more input transducers, a signal processing device, an amplification device and an output transducer. The input transducer is generally a sound receiver, e.g. a microphone, and/or an electromagnetic receiver, e.g. an induction coil. The output transducer is generally implemented as an electroacoustic converter, e.g. miniature loudspeaker, or as an electromechanical converter, e.g. bone conduction earpiece. It is also referred to as an earpiece or receiver. The output transducer creates output signals which are conveyed to the hearing of the patient and are configured to create a perception of hearing in the patient. The amplifier is generally integrated into the signal processing device. The hearing device is supplied with power by a battery integrated into the hearing device housing. The main components of a hearing device are generally arranged on a printed circuit board as a circuit carrier or are connected thereto.

Hearing instruments, as well as being configured as hearing devices, can also be configured as what is referred to as tinnitus maskers. Tinnitus maskers are used for the therapy of tinnitus patients. They create acoustic output signals depending on the respective hearing impairment and, in accordance with their principle of operation, also depending on ambient noises, which can contribute to reducing the perception of disruptive tinnitus or other noises in the ear.

Hearing instruments can also be configured as telephones, cell phones, headsets, headphones, MP3 players or other telecommunications or consumer electronics systems.

The term hearing instrument below is intended to be understood as both hearing devices and also tinnitus maskers, comparable devices of this type, as well as telecommunications and consumer electronics systems.

Various basic types of hearing instruments, especially hearing devices, are known. With in-the-ear (ITE) hearing devices a housing containing all functional components including the microphone and the receiver is worn at least partly in the auditory canal. Completely-in-canal (CIC) hearing devices are similar to the ITE hearing devices but are worn entirely in the auditory canal. With behind-the-ear (BTE) hearing devices a housing with components such as battery and signal processing device is worn behind the ear and a flexible sound tube conducts the acoustic output signals of a receiver from the housing to the auditory canal, where frequently an earpiece is provided on the tube for reliable positioning of the tube end in the auditory canal. Receiver-in-canal behind-the-ear (RIC-BTE) hearing devices are similar to the BTE hearing devices, however the receiver is worn in the auditory canal and instead of a sound tube a flexible receiver tube conducts electrical signals instead of acoustic signals to the receiver which is attached to the front of the receiver tube, mostly in an earpiece used for reliable positioning in the auditory canal. RIC-BTE hearing devices are frequently used as so-called open-fit devices, in which for reducing the disruptive occlusion effect, the auditory canal remains open for the passage of sound and air.

Deep-fit hearing devices are similar to the CIC hearing devices. While CIC hearing devices are generally worn however in a further-out (distal) section of the outer auditory canal, deep-fit hearing devices are pushed further in towards the eardrum (proximal) and are worn at least partly in the inner section of the outer auditory canal. The outer section of the auditory canal is a canal lined with skin and connects the ear muscle to the eardrum. In the outer section of the outer auditory canal which directly adjoins the ear muscle this canal is formed from elastic cartilage. In the inner section of the outer auditory canal the canal is formed from the temporal bone and thus consists of bone. The course of the auditory canal between the cartilaginous section and the bone section is generally angled in a (second) bend and encloses an angle which differs from person to person. The bony section of the auditory canal in particular is comparatively sensitive to pressure and movements. Deep-fit hearing devices are worn at least partly in the sensitive bony section of the auditory canal. On insertion into the bony section of the auditory canal they also have to pass the aforesaid bend which, depending on the angle, can be difficult. In addition small diameters and winding forms of the auditory canal can further complicate the insertion.

And as well as the hearing device types to be worn on or in the ear with acoustic receiver, cochlea implants and bone-anchored hearing aids (BAHA) are also known.

Common to all hearing device types is that they aim to have the smallest possible forms of housing or construction in order to enhance the wearing comfort, where necessary to improve the implantability and if necessary to reduce the visibility of the hearing device for cosmetic reasons. The aim of having the smallest possible configuration also applies to most other hearing instruments.

In order to obtain a small configuration it is known that hearing instruments can be equipped with an on-off switch which is not provided separately. Instead an electric contact to the battery is interrupted or established by opening or closing the battery compartment. For this purpose the battery contacts required in any event, usually embodied as metal tongues, can simultaneously assume the function of the on-off contact.

In order to make the on/off function possible the battery contacts are shaped and disposed so that at least one of the contacts is lifted away from the battery by a corresponding contour in the battery compartment when the compartment is opened. The contour is electrically insulated from the battery and is disposed between the battery contacts and the battery. It lifts the battery contact away from the battery against an elastic force. The elastic force causes increased friction between the battery contact on the one hand and the battery or contour on the other hand. The contour normally disposed in the fold-out battery compartment is worn out by the friction. Conversely, if the contour does not lift it up, the battery contact is elastically lowered onto the battery.

### SUMMARY OF THE INVENTION

It is accordingly an object of the invention to provide a hearing instrument with a battery compartment switch that overcomes the above-mentioned disadvantages of the prior art devices of this general type, which operates reliably over the long term and exhibits reduced wear, especially by abrasion or rubbing away during actuation.

The invention achieves the object by a battery compartment switch for a hearing instrument with the features of the independent claim.

A basic idea of the invention consists of a battery compartment switch for a hearing instrument. The hearing instrument contains a housing, a battery compartment able to be moved into and out of the housing, a battery contact device with a contact area for electrically contacting a battery inserted into the battery compartment. The battery contact device is disposed on one of the housing or the battery compartment, and an on/off contour is disposed on the other of the housing or the battery compartment for interrupting the electrical contact between the battery contact device and the battery when the battery compartment is moved out of the housing. The on/off contour interacts with a lift-off area of the battery contact device when the battery compartment is moved out of the housing. The lift-off area and the contact area are disposed separately from one another and the on/off contour and the battery contact device are embodied such that, when the battery compartment is moved out, the contact device is lifted such that there is no mutual friction between contact area and on/off contour.

The basic idea thus consists of using an on/off contour provided in the area of the battery compartment and a correspondingly shaped battery contact device, the shapes of which are tailored to one another such that the lift-off area for lifting the battery contact device away from the battery and the contact area of the battery contact device are separated from one another. Accordingly the battery contact device has two specific areas separated from one another, a lift-off area and a contact area. The two areas can each be configured separately in order on the one hand to reduce the wear on the on/off contour and on the other hand to guarantee that secure electrical contact is made with the battery.

Advantageously a lift-off area with a large surface area can be provided by the invention, through which the mechanical pressure on the on/off contour is distributed over a larger surface area and is thus reduced; this lessens the friction wear. Through a suitable configuration of the on/off contour a single shaped area in the battery contact device can be sufficient to guarantee both the lift-off function and also the contact function; the shape of the battery contact device is simplified by this. A reduced bending angle for lifting off the battery contact device is also made possible which makes it possible to use an increased number of materials with the lower bending stiffness. Last but not least the reliability of the actual on/off function is increased.

An advantageous development of the basic idea consists of the battery contact device being embodied as a conductive elastic tongue.

A further advantageous development of the basic idea consists of the contact area and the lift-off area of the battery contact device being formed by a common bulge of the tongue. This produces a lower degree of complexity of the battery contact device, making the device more reliable. In addition manufacturing is also simplified by the lower complexity.

A further advantageous development of the basic idea consists of the on/off contour having a first contour area in which the interaction with the lift-off area of the battery contact device is minimized such that the contact area can contact the battery, and a second contour area which interacts with the lift-off area such that a lifting away of the contact area from the battery is affected.

A further advantageous development of the basic idea consists of the second contour area having a cutout or recess for non-contact accommodation of the contact area. This prevents friction which could wear out the contact area and adversely affect its electrical conductivity.

A further advantageous development of the basic idea consists of the battery compartment being supported in one axis pivotably in the housing, so that it is able to be moved by pivoting around the axis into the housing and out of the housing, and wherein the second contour area runs along a circular path, concentric to the axis. This embodiment with the form of a concentric circular path guarantees that the contact area of the battery contact device, when the battery compartment is pivoted, remains in the cutout or recess which is formed in the second contour area. In this way friction on the contact area is prevented during pivoting of the battery compartment.

Other features which are considered as characteristic for the invention are set forth in the appended claims.

Although the invention is illustrated and described herein as embodied in a hearing instrument with a battery compartment switch, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a hearing instrument according to the invention;

FIG. 2 is a diagrammatic, perspective view of a battery contact device;

FIG. 3 is a diagrammatic, sectional view of the battery contact device and an on/off contour;

FIG. 4 is a diagrammatic, sectional view of the battery contact device and the on/off contour;

FIG. 5 is a top plan view of a battery compartment pivoted in;

FIG. 6 is a top plan view of the battery compartment pivoted out;

FIG. 7 is a diagrammatic, perspective view of the battery contact device;

FIG. 8 is a diagrammatic, sectional view of the battery contact device and the on/off contour;

FIG. 9 is a diagrammatic, sectional view of the battery contact device and the on/off contour;

FIG. 10 is a top plan view of the battery compartment pivoted in; and

FIG. 11 is a top plan view of the battery compartment pivoted out.

### DETAILED DESCRIPTION OF THE INVENTION

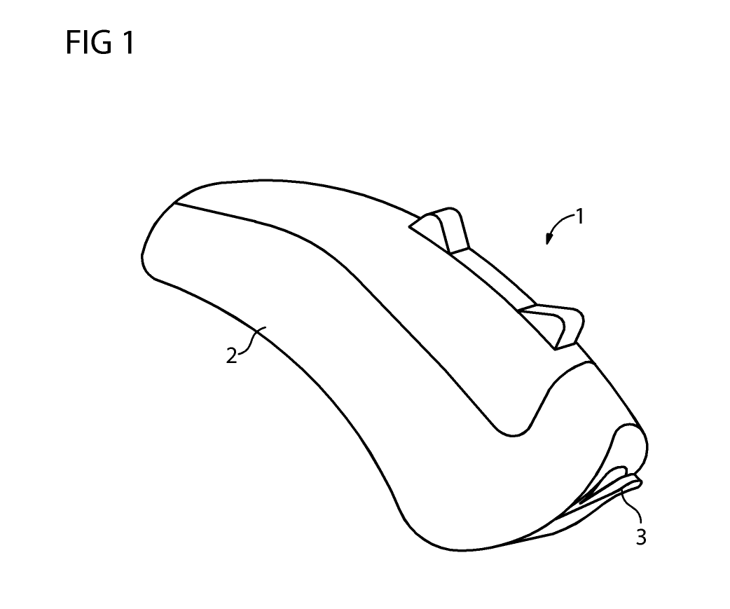

Referring now to the figures of the drawings in detail and first, particularly to FIG. 1 thereof, there is shown a perspective view of a hearing instrument 1. The hearing instrument 1 is a BTE hearing device with a housing 2 and a battery compartment 3. The instrument shown involves a conventional BTE hearing device, wherein a hearing tube intended to lead to the ear is not shown in FIG. 1. Disposed inside the housing 2 or the battery compartment 3 is a form of embodiment of a battery contact device in accordance with the invention, as will be explained in conjunction with the subsequent figure descriptions.

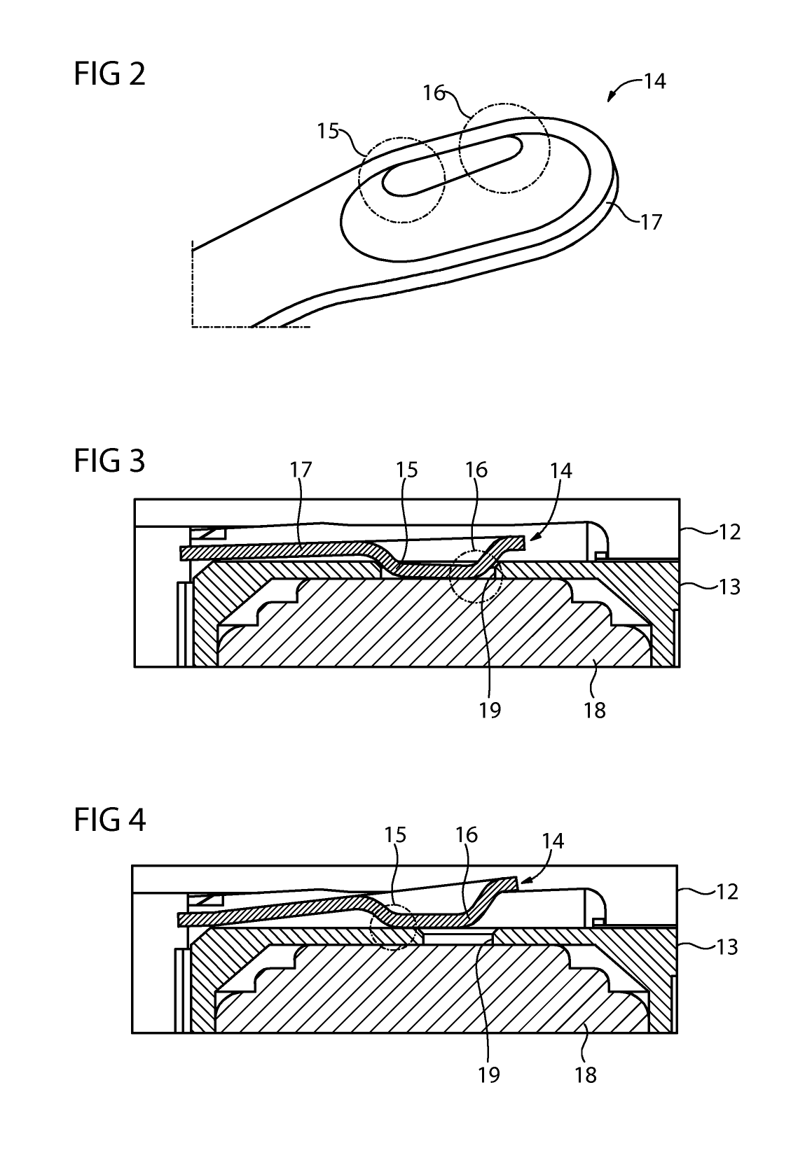

FIG. 2 shows a perspective diagram of a battery contact device 14. The battery contact device 14 has an elongated bulge, which is molded into an elastic, conductive tongue 17. The elastic, conductive tongue 17 can consist of materials conventionally used for contacting batteries, for example a sprung metal. The protrusion in the tongue 17 forms a raised area, which includes a contact area 16 and a separately arranged lift-off area 15 disposed next to it. The contact area 16 is used for contacting the battery and the lift-off area 15 is used for lifting the contact area 16 away from the battery. The function of the lift-off area 15 and of the contact area 16 will be explained in greater deal with reference to the subsequent figures.

FIG. 3 shows a section of a cross-section of the hearing instrument with the battery contact device 14 and an on/off contour 19. The tongue 17 is lowered onto a battery 18 such that the contact area 16 touches the battery 18 and thus electrical contact is established. The lift-off area 15 is not or at any rate not significantly interacting with the on/off contour 19 of a battery compartment 13.

The battery compartment 13 is disposed in a housing 12 of the hearing instrument and can be moved into and out of the housing. It is of secondary importance for the interaction of the battery contact device 14 and the on/off contour 19 whether the battery compartment 13 is pushed into the housing 12, pivoted into it or moved into it and out of it in some other way. The form of embodiment shows represents a pivotable battery compartment 13, as will subsequently become evident. In the figure the battery compartment 13 is moved fully into the housing 12. The battery compartment switch formed by the on/off contour 19 and the battery contact device 14 is closed and electrical contact to the battery 18 is established. The hearing instrument is thus switched on.

FIG. 4 shows the preceding section once more, however the battery compartment 13 is not completely moved into the housing 12. Instead it is pivoted far enough out of the housing to switch the hearing instrument off. A catch can conventionally be provided for this position of the battery compartment 13, which prevents the battery compartment 13 pivoting right out of the housing 12. The catch helps to prevent the battery compartment 13 unintentionally pivoting right out and the battery 18 being able to fall out in an unwanted manner.

The on/off contour 19, in the position of the battery compartment 13 shown, interacts with the lift-off area 15 of the battery contact device 14. Through this the battery contact device 14 is lifted up as shown, which lifts the contact area 16 away from the battery 18. The electrical contact to the battery is thus interrupted. In order, in this position of the battery compartment 13 or of the battery contact device 14, to insure that no undesired electrical contact to the battery 18 remains, the on/off contour 19 or the battery compartment 13 is manufactured from electrically-insulating material. Conventional materials can be used for this purpose, for example plastic.

The battery compartment switch formed by the battery contact device 14 and the on/off contour 19 thus interrupts contact to the battery 18 and the hearing instrument is switched off.

FIG. 5 shows the battery compartment 13 along with its housing 12 in an overhead view. Those parts of the housing 12 which would prevent the battery compartment 13 being seen in an overhead view are omitted from the diagram. The battery compartment 13 is completely pivoted into the housing 12. The hearing instrument is thus switched on. The pivoting movement of the battery compartment 13 occurs around an axis 22, through which it is pivotably supported in the housing 12.

Essentially only the bulge of the battery contact device with the lift-off area 15 and the contact area 16 can be seen. The on/off contour 19 is a least partly embodied as an opening in the battery compartment 13, so that a battery not shown in the diagram can be contacted through this opening by the contact area 16. In the view shown the battery would lie above the contact area 16 and thus hide the area.

The on/off contour 19 includes a contour area 21, of which the shape is essentially congruent to the form of the bulge of the battery contact device. The significant aspect of the shape of the contour area 21 is that on the one hand it allows electrical contact of the contact area 16 to the battery and on the other hand it avoids an interaction between the lift-off area 15 which would lead to the lifting of the contact area 16 away from the battery. For this purpose it is not necessary for the contour area 21 to be congruent to the bulge of the battery contact device, as is shown in the diagram. Instead the contour area 21 could also be embodied as a larger opening of a different shape.

The on/off contour 19 contains a further contour area 20 which, in the pivoted position of the battery compartment 13 shown, does not perform any function for the battery compartment switch. The contour area 20 essentially extends along a circular path concentric to the axis 22. It can be seen that the contact area 16, when the battery compartment 13 is pivoted out (in the counterclockwise direction in the diagram) is essentially covered by the opening which is provided in the contour area 20.

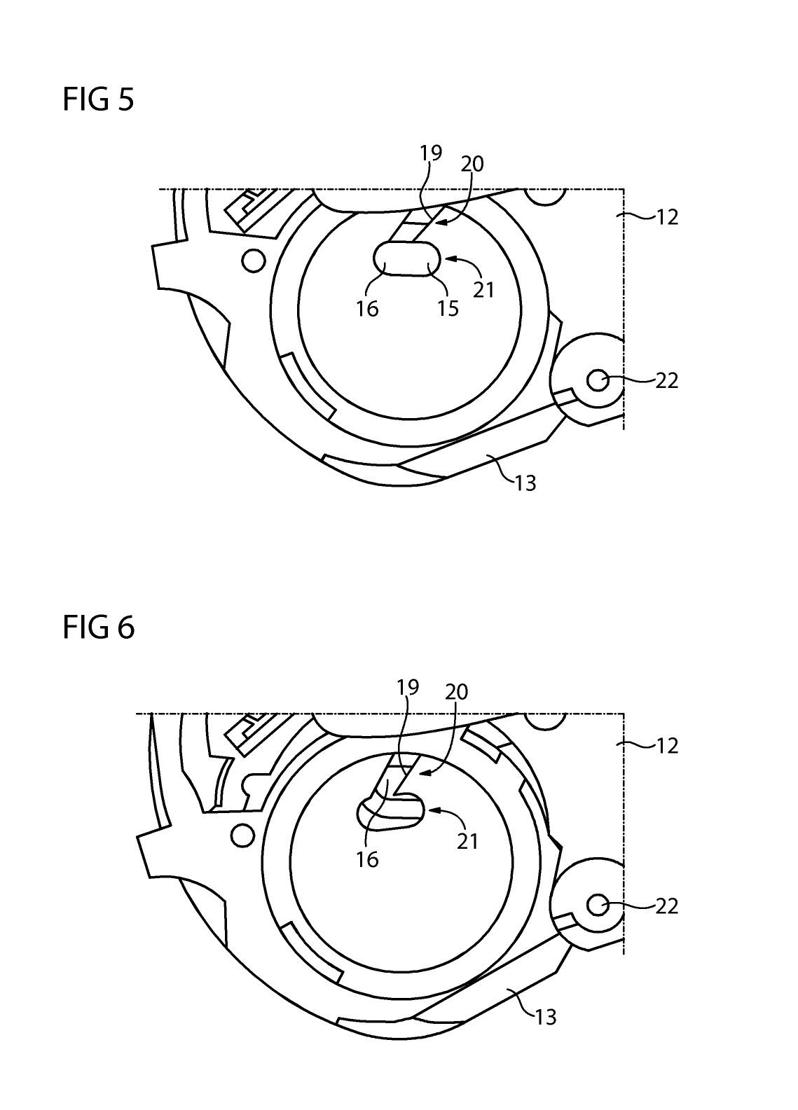

In FIG. 6 the previous diagram is shown once again, with the battery compartment 13 in a different position. The battery compartment 13 is pivoted far enough out of the housing 12 for the hearing instrument to be switched off by the battery compartment switch.

The bulge of the battery contact device connected to the housing 12 is covered by the on/off contour 19 connected to the battery compartment 13 when the battery compartment 13 is pivoted out. This causes an interaction to arise between the contour area 20 and the lift-off area 19, which leads to the battery contact device being lifted away from the battery. Thus the contact area 16 is no longer in electrical contact with the battery. In the perspective shown the battery contact device is pivoted downwards into the plane of the drawing. It is evident that the contact area 16 is disposed in the opening provided in the contour area 20. This avoids mechanical friction between the contact area 16 and the on/off contour 19 or the battery compartment 13 respectively. This prevents wear to the contact area 16. This is essentially made possible by the lifting off of the battery contact device which is effected by mechanical interaction, with the lift-off area 15, being affected by the lift-off area 15 disposed separately from the contact area 16. The mechanical wear inevitably occurring during mechanical lifting off is thus displaced to the lift-off area 15. This makes it possible to configure the lift-off area 15 on the one hand and the contact area 16 on the other hand for the respective separate purpose. Accordingly the contour area 20 is embodied so that mechanical wear of the battery compartment 13 is minimized in the contour area 20. To this end on the one hand a shape can be selected which transfers the mechanical forces to a large area, through which the pressure between the components is reduced and thus the friction is also reduced, on the other hand suitable materials with a corresponding hardness and a corresponding coefficient of friction can be used.

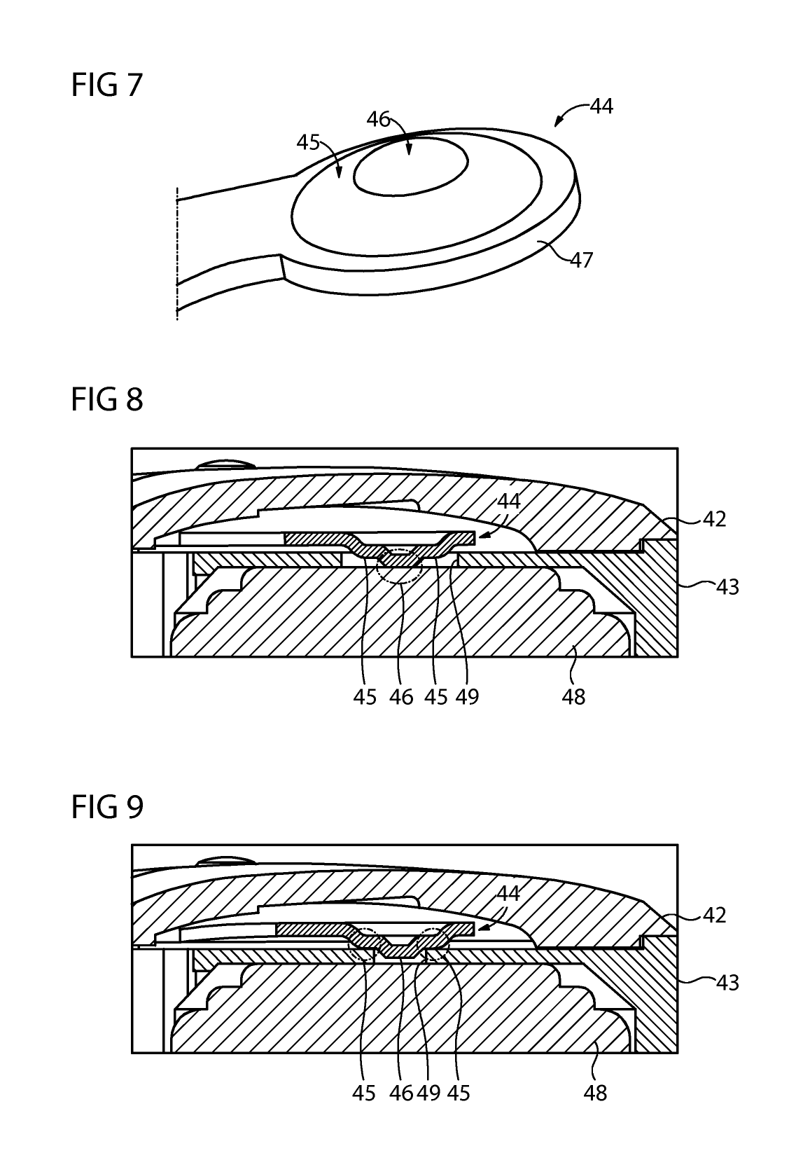

FIG. 7 shows a battery contact device 44 in another form of embodiment. The bulge of the tongue 44 is circular. A contact area 46 represents the highest, central component of the bulge, around which a lift-off area 45 is disposed concentrically.

FIG. 8 shows a section of the hearing instrument as a cross-sectional diagram. In the section the form of embodiment of the battery contact device 44 shown previously is inserted. A battery compartment 43 is completely pivoted into the housing 42, so that the hearing instrument is switched on. The contact area 46 is in electrical contact with a battery 48. An on/off contour 49 is not interacting with the lift-off area 45. Thus the battery contact device 44 is lowered onto the battery 48.

FIG. 9 depicts the section previously shown once again, however with the battery compartment 43 pivoted out into the off position. Through the pivoting out of the battery compartment 43 the on/off contour 49 is interacting mechanically with the lift-off area 45. Through this action the battery contact device 44 is lifted away from the battery 48 so that the electrical contact between the battery 48 in the contact area 46 is interrupted. Through this action the hearing instrument is switched off by the battery compartment switch formed by the battery contact device 44 and the on/off contour 49.

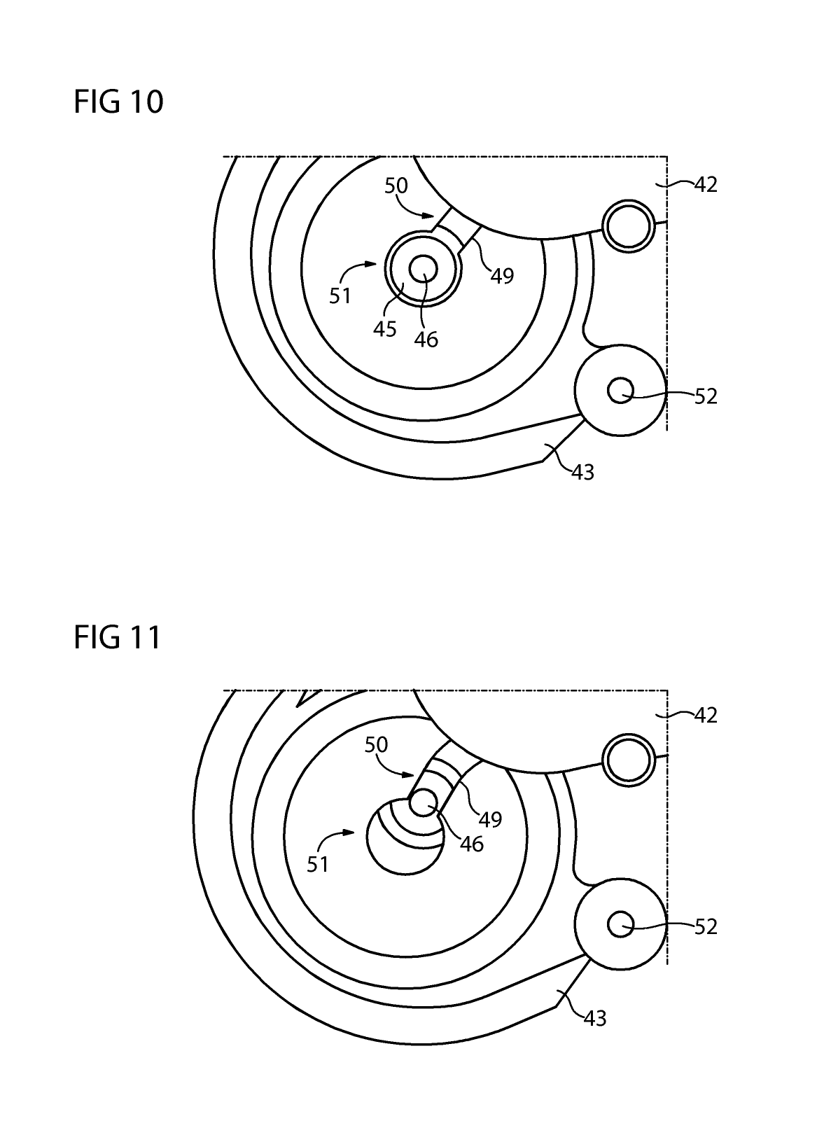

FIG. 10 shows the form of the embodiment with the circular contact area 46 and concentric circular lift-off area 45 viewed from above and without battery. Parts of the housing 42 which would hide the view of the contact device are omitted. The battery compartment 43 is fully pivoted into the housing 42. The bulge of the battery contact device formed by the contact area 46 and the lift-off area 45 is located in a contour area 51 by the battery contact device being lowered and electrical contact being established between the contact area 46 and the battery. Although the contour area 51 is essentially aligned congruent to the bulge of the battery contact device, it can also have a larger and different shape. Of importance for the design of the contour area 51 is only that on the one hand the battery contact device is not or at least insignificantly lifted and on the other hand that the electrical contact between contact area 46 and the battery arranged above the area in the diagram is made possible.

FIG. 11 shows the previous section once again, but with the battery compartment 43 pivoted out in the off position. The contour area 50 of the on/off contour 49 is interacting in this position of the battery compartment 43 with the lift-off area 45 of the battery contact device. This lifts the device away from the battery, so that the electrical contact between the contact area 46 and the battery is interrupted. Thus the hearing instrument is switched off by the battery compartment switch formed by the on/off contour 49 and the battery contact device.

It is further evident that the contact area 46 is disposed in the opening in the contour area 50, so that it is not subjected to any kind of friction. The prevention of friction wear is important here, which is why instead of an opening in the contour area 50, a sufficiently deep recess can also be provided.

Because friction forces do not act on the contact area 46 the area's mechanical wear is reduced. Mechanical forces are instead relocated to the lift-off area 45 separated therefrom, which can accordingly be embodied to optimize the mechanical characteristics and minimize the friction wear. On the on/off contour 49 side mechanical forces primarily engage in the contour area 50, which interacts with the lift-off area 45. The contour area 50 can accordingly on the one hand be embodied with a large surface area in order to minimize the pressure and thus friction forces between the contour area 50 and the lift-off area 45. On the other hand the contour area 50 can be manufactured from materials with suitable hardness and coefficients of friction.

1. A battery compartment switch for a hearing instrument, the battery compartment switch comprising:
a housing;
a battery compartment able to be moved into and out of said housing;
a battery contact device with a contact area for electrical contacting of a battery inserted into said battery compartment, wherein said battery contact device disposed on one of said housing or said battery compartment, said battery contact device further having a lift-off area, said lift-off area and said contact area disposed separately from one another;
an on/off contour disposed on the other of said housing or said battery compartment not having said battery contact device, for interrupting an electrical contact between said battery contact device and the battery, wherein said on/off contour, when said battery compartment is moved out, interacts with said lift-off area of said battery contact device; and
said on/off contour and said battery contact device embodied such that, when said battery compartment is moved out, said battery contact device is lifted such that no mutual friction occurs between said contact area and said on/off contour.

2. The battery compartment switch according to claim 1, wherein said battery contact device is a conductive, elastic tongue.

3. The battery compartment switch according to claim 2, wherein said contact area and said lift-off area of said battery contact device are formed by means of a common bulge of said conductive, elastic tongue.

4. The battery compartment switch according to claim 1, wherein said on/off contour has a first contour area in which an interaction with said lift-off area of said battery contact device is minimized such that said contact area can contact the battery and a second contour area, which interacts with said lift-off area such that said contact area is lifted away from the battery.

5. The battery compartment switch according to claim 4, wherein said second contour area has a cutout or recess formed therein for non-contact accommodation of said contact area.

6. The battery compartment switch according to claim 5, wherein said battery compartment is supported in an axis pivotably in said housing, so that said battery compartment is able to be moved by pivoting around the axis into said housing and out of said housing, and wherein said second contour area runs along a circular path concentric to the axis.
